(19) United States
(12) Patent Application Publication
(10) Pub. No.: US 2018/0125320 A1
(43) Pub. Date: May 10, 2018

(54) OPTIMIZING AUTOMATED FLOOR-CARE DEVICES

(71) Applicants: Michael Peck, Manchester, CT (US); Joseph L. Jones, Acton, MA (US); Paul Cappa, Enfield, CT (US)

(72) Inventors: Michael Peck, Manchester, CT (US); Joseph L. Jones, Acton, MA (US); Paul Cappa, Enfield, CT (US)

(21) Appl. No.: 15/807,884

(22) Filed: Nov. 9, 2017

Related U.S. Application Data
(60) Provisional application No. 62/419,553, filed on Nov. 9, 2016.

(51) Int. Cl. A47L 11/40; G05B 13/02; G05B 19/406; A47L 11/30; A47L 11/282

(52) U.S. Cl. CPC A47L 11/4011; G05B 13/024; G05B 19/406; A47L 11/302; A47L 11/4022; A47L 11/4091; C02F 2103/002; A47L 11/282; A47L 11/4002; G05B 2219/45098; A47L 2201/04; A47L 2201/06; A47L 11/4083

(57) ABSTRACT

An apparatus in one embodiment comprises a processing platform that includes one or more processing devices each comprising a processor coupled to a memory. The processing platform is configured to implement at least a portion of at least a first floor-care system. The processing platform further comprises a floor-care input variable monitoring module configured to monitor, during run-time of a floor-care operation in connection with a given space, multiple floor-care variables input by at least the first floor-care system, a floor-care execution adjustment module configured to adjust one or more of multiple floor-care execution outputs in response to the monitoring of the multiple floor-care variables, and a floor-care output module configured to execute at least a portion of the multiple floor-care execution outputs during at least a portion of the floor-care operation based on the one or more adjusted floor-care execution outputs.

### CROSS-REFERENCE TO RELATED APPLICATIONS

This application claims priority to U.S. Provisional Application Ser. No. 62/419,553, filed Nov. 9, 2016, incorporated by reference herein.

### FIELD

The field relates generally to information processing systems, and more particularly to automatic floor-care devices utilizing information processing systems.

### BACKGROUND

Floor-care robots and/or automated devices are increasingly prevalent, particularly in commercial settings. However, while manufacturers of floor-cleaning agents and solutions commonly recommend protocols for using such products efficaciously with automated devices, users of automated floor-care devices typically fail to utilize or implement objective measurements of cleanliness. Accordingly, such qualification and quantification inefficiencies, in conjunction with the prevalence of temporal constraints routinely associated with the use of such automated devices, commonly result in sub-optimal floor-care outcomes, despite the advantages otherwise provided by automated devices.

### SUMMARY

Illustrative embodiments of the present invention provide information processing systems configured to optimize automated floor-care devices and/or robots.

In one embodiment, an apparatus comprises a processing platform that includes one or more processing devices each comprising a processor coupled to a memory. The processing platform is configured to implement at least a portion of at least a first floor-care system. The processing platform further comprises a floor-care input variable monitoring module configured to monitor, during run-time of a floor-care operation in connection with a given space, multiple floor-care variables input by at least the first floor-care system, a floor-care execution adjustment module configured to adjust one or more of multiple floor-care execution outputs in response to the monitoring of the multiple floor-care variables, and a floor-care output module configured to execute at least a portion of the multiple floor-care execution outputs during at least a portion of the floor-care operation based on the one or more adjusted floor-care execution outputs.

Illustrative embodiments can provide significant advantages relative to conventional automated cleaning devices. For example, challenges associated with the limitations of systems failing to utilize or implement objective measurements of cleanliness are overcome through integrated capabilities for analyzing an ongoing cleaning process and real-time environmental variables to determine an optimization of one or more outputs of the automated device. Such optimizations facilitate efficient cleaning operations, safer operating environments, and avoidance of overuse of cleaning agents and chemicals.

These and other illustrative embodiments described herein include, without limitation, methods, apparatus, systems, and computer program products comprising processor-readable storage media.

### BRIEF DESCRIPTION OF THE DRAWINGS

FIG. 1 is a block diagram of an information processing system configured for optimizing automated floor-care devices in an illustrative embodiment.

FIG. 2 shows system architecture including subsystems, inputs and outputs in an illustrative embodiment.

FIG. 3 shows example mapping of systems, components and variables in an illustrative embodiment.

FIG. 4 shows a flow diagram of a process for optimizing automated floor-care devices in an illustrative embodiment.

FIG. 5 shows examples of processing platforms that may be utilized to implement at least a portion of an information processing system in illustrative embodiments.

### DETAILED DESCRIPTION

Illustrative embodiments of the present invention will be described herein with reference to exemplary information processing systems and associated computers, servers, storage devices and other processing devices. It is to be appreciated, however, that embodiments of the invention are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or type of cloud-based system that includes one or more clouds hosting tenants that access cloud resources. Numerous other system configurations are possible in other embodiments.

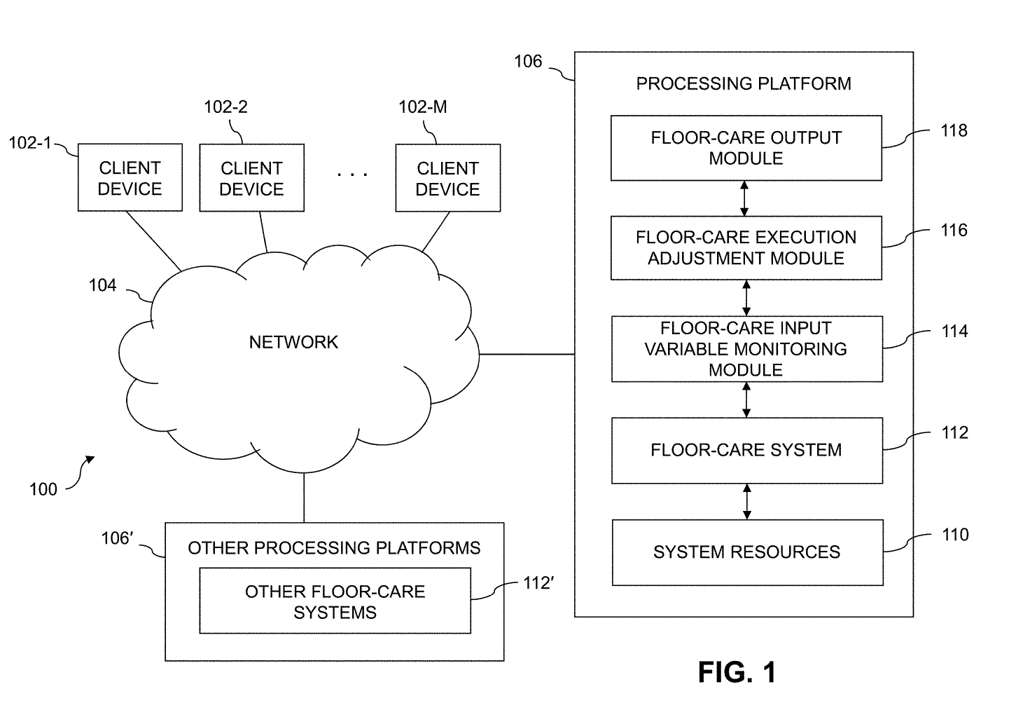

FIG. 1 shows an information processing system 100 configured in accordance with an illustrative embodiment of the invention. The information processing system 100 comprises a plurality of client devices 102-1, 102-2, . . . 102-M coupled via a network 104 to a processing platform 106.

The client devices 102 in this embodiment can comprise, for example, automated and/or robotic floor-care devices, as well as desktop, laptop or tablet computers, mobile telephones, or other types of processing devices capable of communicating with the processing platform 106 over the network 104. Clients associated with the respective client devices 102 are assumed to run respective sets of client applications utilizing corresponding sets of system resources 110 (which can include, for example, virtual resources) of at least one floor-care system 112 (which can include, for example, a cloud-based system) provided by the processing platform 106. In some embodiments, the system resources 110 comprise a plurality of containers allocable to respective client applications under the control of the floor-care system 112. Various combinations of containers, virtual machines and other virtual resources may be used in other embodiments.

The network 104 over which the client devices 102 and the processing platform 106 communicate illustratively comprises one or more networks including, for example, a global computer network such as the Internet, a wide area network (WAN), a local area network (LAN), a satellite network, a telephone or cable network, a cellular network, a wireless network implemented using a wireless protocol such as Wi-Fi or WiMAX, or various portions or combinations of these and other types of communication networks.

The processing platform 106 is assumed to include one or more processing devices each having a processor coupled to a memory, and is configured to implement at least a portion of at least a first system (such as, for example, virtual resources of a cloud-based system) for use by client applications.

The processing platform 106 further comprises a floor-care input variable monitoring module 114, a floor-care execution adjustment module 116 and a floor-care output module 118, each associated with the floor-care system 112. The floor care system 112 can include, for example, a cloud-based system, which can also be referred to herein as a “cloud.”

Examples of different types of clouds that may be utilized in illustrative embodiments include private, public and hybrid clouds. Private clouds illustratively include on-premises clouds and off-premises clouds, where “premises” refers generally to a particular site or other physical location of the business, enterprise, organization or other entity that utilizes the private cloud. Public clouds are assumed to be off-premises clouds. Hybrid clouds comprise combinations of public and private clouds and thus may include various combinations of on-premises and off-premises portions.

The floor-care input variable monitoring module 114 is configured to monitor, during run-time of a floor-care operation in connection with a given space, multiple floor-care variables input by at least the first floor-care system. The floor-care execution adjustment module 116 is configured to adjust one or more of multiple floor-care execution outputs in response to the monitoring of the multiple floor-care variables. The floor-care output module 118 is configured to execute at least a portion of the multiple floor-care execution outputs during at least a portion of the floor-care operation based on the one or more adjusted floor-care execution outputs.

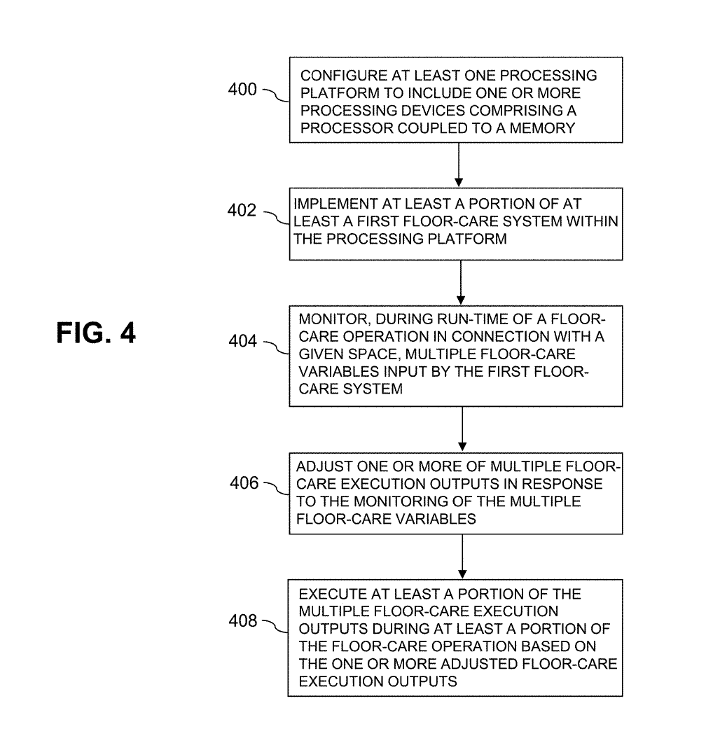

An exemplary process utilizing floor-care input variable monitoring module 114, floor-care execution adjustment module 116, and floor-care output module 118 of the processing platform 106 in information processing system 100 will be described in more detail with reference to the flow diagram of FIG. 4.

Also, by way of example, in some embodiments, a different floor-care system comprises another floor-care system implemented with floor-care system 112 on the processing platform 106. Alternatively, the different floor-care system can comprise another floor-care system 112′ implemented on a different processing platform 106′ coupled to the network 104.

It is to be appreciated that the particular processing platform configuration illustrated in the FIG. 1 embodiment is presented by way of example only, and that other embodiments can utilize other arrangements of additional or alternative components. For example, functionality disclosed herein as being associated with two or more separate components can in other embodiments be combined into a single component.

In some embodiments, certain functionality of the floor-care system 112 is made available to a user by a cloud service provider on a Software-as-a-Service (SaaS) basis. Such users may be associated with respective ones of the client devices 102 and may correspond to respective tenants of the cloud service provider.

However, the term “user” in this context and elsewhere herein is intended to be more broadly construed so as to encompass, for example, human, hardware, software or firmware entities, as well as various combinations of such entities.

It should be understood that the particular arrangements of system and platform components as illustrated in FIG. 1 are presented by way of example only. In other embodiments, only subsets of these system and platform components, or additional or alternative sets of components, may be used, and such components may exhibit alternative functionality and configurations.

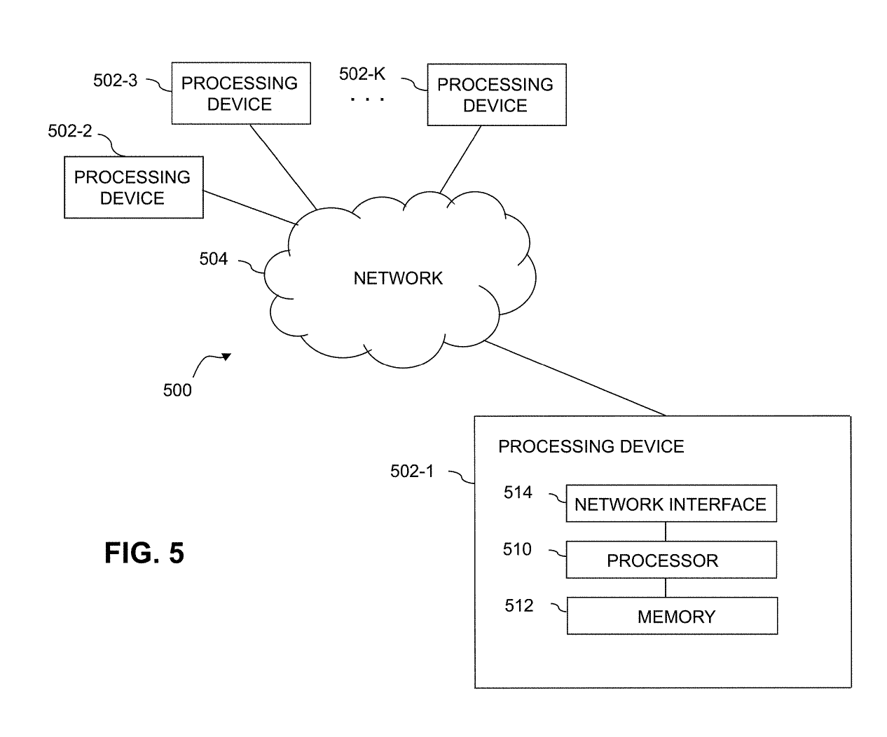

Examples of processing platforms that may be used to implement at least portions of the processing platform 106 of the FIG. 1 embodiment will be described in more detail below in conjunction with FIG. 5. A given such processing platform comprises at least one processing device comprising a processor coupled to a memory, and the processing device may be implemented at least in part utilizing one or more virtual machines or other virtualization infrastructure. Additionally, the operation of the information processing system 100 will be described in further detail with reference to the flow diagram of FIG. 4.

In one or more example embodiments of the invention, as further detailed herein, an automated floor-care device (such as a robot floor scrubber, for example) can be implemented with control software via processing platform 106 that can be utilized to optimize a floor-care operation using the temperature, agitation, concentration, time (TACT) circle. The TACT circle leverages four parameters to determine the efficacy of a cleaning or floor-care process: T, the temperature at which the process takes place; A, the agitation or aggressiveness of the cleaning action; C, the concentration of the cleaning agent; and T, the time permitted for the process. Additionally, as implemented in one or more embodiments of the invention, to maintain a given level of cleaning efficacy, one of the four parameters of the TACT circle can be increased in conjunction with another parameter being decreased, so as to maintain a constant sum of the TACT circle.

At least one embodiment of the invention includes representing the TACT circle algorithmically. By way of example, suppose that the manufacturer of a cleaning solution recommends that cleaning be carried out at temperature Tₒ, with agitation amount Aₒ, at concentration level Cₒ, for a time of Zₒ. For such a scenario, the TACT circle constraint can be expressed as: tTₒ+aAₒ+cCₒ+zZₒ=1 (Eq. 1). The coefficients t, a, c, and z ensure that each term of the equation is dimensionless, that each quantity is equally represented, and that the sum of the manufacturer-recommended values equals 1. One or more embodiments of the invention can include imposing one or more additional constraints, such as, for example, that all coefficients must be greater than 0. In utilizing the above noted equation, it can be seen that if the value of one of the cleaning parameters is, for example, decreased, the sum can be maintained by increasing one or more of the other parameter values.

As further detailed herein, in one or more embodiments of the invention, the above-described TACT circle control algorithm (Eq. 1) can be programmed into an automated and/or robotic floor-care device (such as a scrubber).

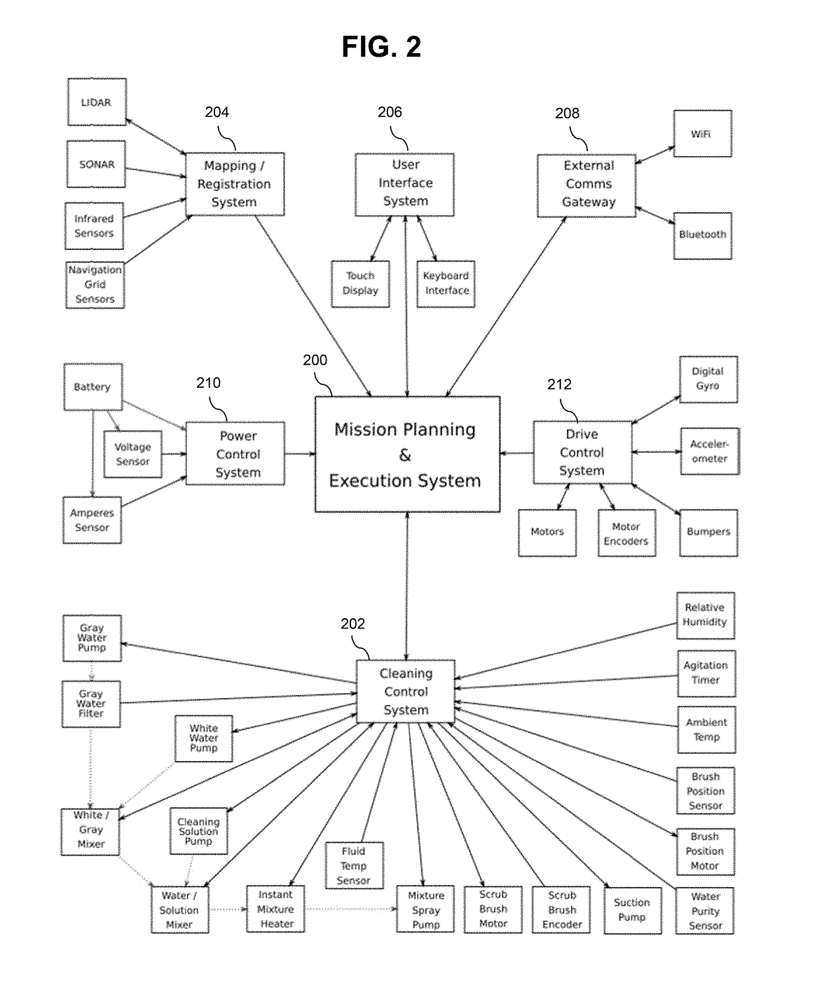

FIG. 2 shows system architecture including subsystems, inputs and outputs in an illustrative embodiment. By way of illustration, FIG. 2 depicts a mission planning and execution system 200, which receives input from a mapping and/or registration system 204, a user interface system 206, an external communications gateway 208, a power control system 210 and a drive control system 212. Additionally, as illustrated in FIG. 2, the mission planning and execution system 200 interacts with a cleaning control system 202. In one or more embodiments of the invention, the subsystems noted above and further described below can be logical subsystems that physically reside within one or multiple central processing units (CPUs) within the automated and/or robotic floor-care device (such as within processing platform 106, for example).

The cleaning control system (CCS) 202 can embody functions to control a cleaning process, and can utilize multiple inputs (via, for example, relative humidity sensors, an agitation timer, ambient temperature sensors, a brush position sensor, a water purity sensor, a scrub brush encoder, a fluid temperature sensor, a gray water filter, and/or a white/gray mixer) and outputs (via, for example, a brush position motor, a suction pump, a scrub brush motor, a mixture spray pump, a gray water pump, a white water pump, a white/gray mixer, a cleaning solution pump, a water/solution mixer, and/or an instant mixture heater), as further described herein.

Additionally, the mission planning and execution system (MPES) 200 determines how to execute the mission and proceeds to carry out the execution plan. As the automated and/or robotic floor-care device conducts the particular mission, the floor-care device continuously monitors the input variables and, as necessary, adjusts the mission and/or execution plan in light of monitored changes to the input variables, applying the TACT circle algorithm to determine the particular adjustments.

The mapping and registration system (MAP) 204 can utilize simultaneous localization and mapping (SLAM) technology to provide a map of the given space associated with the cleaning or floor-care operation, as well as the localization required to navigate the given space. Additionally, the mapping and registration system 204 can utilize inputs from navigation grid sensors, infrared sensors, sonar, and LIDAR (Light Detection and Ranging) associated with the automated and/or robotic floor-care device.

The user interface system (UIS) 206 can serve as an on-board system to the automated and/or robotic floor-care device that allows a user to operate the device. Such a system ctn include the use of a touch display and/or a keyboard interface. The external communications gateway (XCOMM) 208 provides the ability to send operational commands to the automated and/or robotic floor-care device, monitor the activity of the floor-care device, provide a help platform for service requests, and provide and allow device-device communication for automated and/or robotic floor-care device swarms. Such a system can include the use of Wi-Fi and/or Bluetooth® capabilities.

The power control system (POWER) 210 is responsible for monitoring the power levels of the automated and/or robotic floor-care device and providing information to MPES 200 to allow the floor-care device to optimize cleaning operations. The power control system 210 can encompass one or more batteries of the automated and/or robotic floor-care device, as well as voltage sensors and ampere sensors. When connected to a battery charging station, the power control system 210 can efficiently manage charging of the batteries.

The drive control system (DRIVE) 212 is responsible for handling the motors involved with moving the automated and/or robotic floor-care device, providing odometer information, interfacing to inertial navigation systems, and/or responding to emergency conditions such as bumper strikes or cliff sensors triggers. In addition to motors and bumpers, the drive control system 212 can encompass and/or utilize motor encoders, accelerometers, and a digital gyroscope.

Using the noted subsystems detailed in FIG. 2, an automated and/or robotic floor-care device can, in accordance with one or more embodiments of the invention, automatically adjust its behavior to achieve one or more objective cleaning measurements/goals, given the monitored circumstances and constraints. By way of example, the automated and/or robotic floor-care device can measure the temperature of the cleaning solution in its tank and determine the temperature to be less than the value recommended by the manufacturer. In response, the automated and/or robotic floor-care device computes the extra time needed to compensate (via heating the solution to the recommended temperature), calculates the remaining battery charge, reduces its speed accordingly, and extends the time allocated for the cleaning operation. Additionally, the automated and/or robotic floor-care device can leverage environmental factors such as relative humidity and ambient temperature to determine the solution evaporation rate (and can then use that evaporation rate in a time estimate calculation).

Consider another example scenario wherein a special event causes a restaurant to remain open longer than normal, giving the automated and/or robotic floor-care device less time than usual to clean before the subsequent morning opening. In such an instance, the automated and/or robotic floor-care device can automatically increase the rotation rate of the cleaning pad (boosting the agitation parameter) to achieve the same cleaning objectives in less time.

In another example, assume that a cleaning adjustment is required but the automated and/or robotic floor-care device computes that its batteries contain insufficient charge to execute the optimal strategy. The automated and/or robotic floor-care device can inform the floor-care system (or manager thereof) of the situation and alter its behavior to achieve as much of the cleaning objectives as possible under the circumstances. When the automated and/or robotic floor-care device is low on batter capacity, the automated and/or robotic floor-care device can, for example, reduce the temperature of the cleaning solution and appropriately re-adjust the concentration, agitation, and/or allotted time accordingly.

Additionally, as detailed herein, the automated and/or robotic floor-care device can sense the cleanliness of the surface in question (via one or more variable measurements) and adjust the cleaning solution concentration, cleaning agent agitation, and/or cleaning solution temperature accordingly.

As also detailed herein, particular terms used in description of one or more embodiments of the invention can be defined as follows. For example, white water refers to clean water (for example, tap water), while gray water refers to water recovered from the floor. Additionally, cleanser refers to a cleaning agent, a solution refers to a mixture of cleanser and water, and concentration refers to the percentage of cleanser used to create the solution. Further, an on-board function refers to a function that the automated and/or robotic floor-care device can control without external aid, while an off-board function refers to a function that the automated and/or robotic floor-care device controls by use of an external aid (for example, a docking station).

By way of additional illustration, in at least one embodiment of the invention, an automated and/or robotic floor-care device can control one or more floor-care variables using one or more of the following techniques. For example, an automated and/or robotic floor-care device can calculate the minimum and maximum values for each identified and/or selected parameter, and unless otherwise specified, the automated and/or robotic floor-care device can begin the floor-care operation by using the mid-points between the minimum and maximum values for each of the parameters. Additionally, as the automated and/or robotic floor-care device performs its mission, the automated and/or robotic floor-care device continuously monitors the relevant inputs and variables, and adjusts the TACT circle formulation accordingly. When one or more of the variables are adjusted, the limits of the other variables will also be adjusted (for example, as the solution temperature is decreased, the total mission time will increase).

Further, when a variable reaches the edge of its operating range (for example, the bounds of the minimum or maximum value calculation), at least one embodiment of the invention can include considering the value to be a constant at that level and can no longer be adjusted in the direction of the edge (that is, the variable can still be adjusted in the opposite direction away from the bound/edge). Also, when a variable is at a limit, one or more of the other variables are used to balance the TACT circle algorithm. When, for example, all variables are at their respective limits, the automated and/or robotic floor-care device may require some sort of service (for example, tanks replenished, battery charged, smaller mission defined, etc.). In some instances, the service can include, for example, self-service at a docking station. Additionally, in one or more embodiments of the invention, each input variable can include one or more sub-variables which allow further control and/or manipulation of the floor-care operation by the automated and/or robotic floor-care device in balancing the TACT circle algorithm.

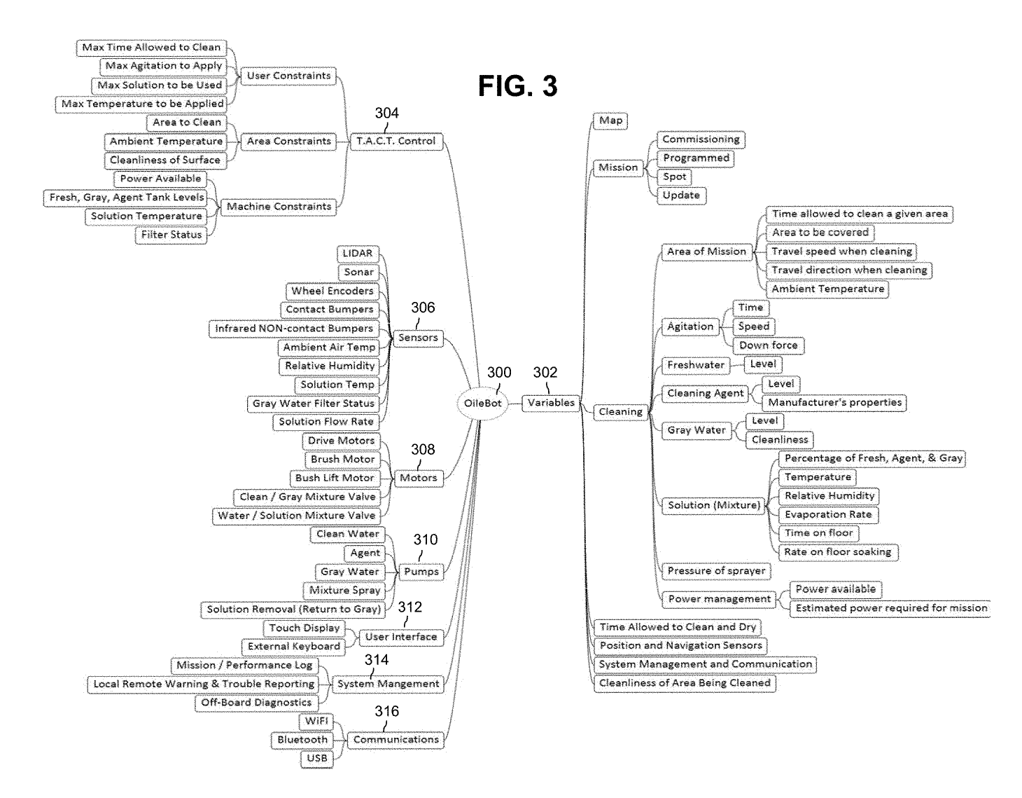

FIG. 3 shows example mapping of systems, components and variables in an illustrative embodiment. By way of illustration, FIG. 3 depicts an automated and/or robotic floor-care device 300, which includes components that include a TACT control component 304 (which can include user constraints, area constraints, and machine/device constraints), sensors 306, motors 308, pumps 310, a user interface 312, a system management component 314 and a communications component 316. The automated and/or robotic floor-care device 300, as also illustrated in FIG. 3, can utilize multiple input variables 302 as further described herein. As also noted herein, in at least one embodiment of the invention, one or more of the variables 302 can be derived by the automated and/or robotic floor-care device 300.

The variables 302 and other inputs illustrated in FIG. 3 and detailed herein include, by way of example, the following. A power available (with respect to the automated and/or robotic floor-care device) variable can be used to determine a total operating time and an amount of time to clean, and can also be used in establishing initial minimum and maximum values for TACT circle algorithm parameters. Additionally, the power available variable can be used in determining the amount of agitation that can be applied.

An area to clean variable can be used in estimating the total time and power required for a particular mission, while a time allowed for an area variable can be used in establishing an upper temporal limit for a mission.

Speed of the vehicle (floor-care device) can be used in connection with time and agitation parameters and can be adjusted to compensate for concentration and temperature adjustments. A solution (water/cleanser) mixture variable can impact the temporal, agitation, and/or temperature parameters of the TACT circle control algorithm (as the weakness or strength of the solution concentration can correspondingly lead to increases or decreases in one or more of those parameters).

An ambient temperature variable can be used to determine a cleaning solution (or water) evaporation rate, and can also be used to predict the amount of time before such a solution is too cool to be effective, or to reduce the speed of the automated and/or robotic floor-care device, to increase agitation of a cleaning agent, etc. Also, a floor temperature variable can be used to determine and/or adjust the value used for the cleaning solution temperature. As such, the cleaning solution temperature variable can be adjusted by variables such as floor temperature, humidity, and ambient temperature.

A dew point variable can be used to determine and/or adjust the value used for the solution temperature, soak time, and/or evaporation time. Similarly, an evaporation rate variable can also be used in calculating a soak time limit. A required soaking time variable represents the required amount of time before an agitation process can begin.

Also, a brush rotation rate can be used in determining and/or adjusting an agitation parameter. A level of fresh/clean water variable can be used in calculating one or more time limits, while a level of gray water variable can be used, if recycled water is used, to adjust one or more time limits. Additionally, a return water cleanliness sensor can be used to determine and/or adjust any or all of the TACT circle algorithm parameters (on a cleaner surface, less of all parameters may be required; on a dirtier surface, more of all parameters may be required).

An area to be cleaned variable can detail the size of the area in question, while a time allowed to clean and dry the area variable can specify circumstance-specific temporal limitations. For example, in some cases (such as, for example, a spill of coffee in a high-traffic area), the area may need immediate cleaning and drying. The resources of the automated and/or robotic floor-care device would then be devoted to cleaning the spill as expeditiously as possible. In a separate example scenario, the automated and/or robotic floor-care device is programmed to clean all designated areas of a kitchen and dining room while the restaurant is vacant, such as by an overnight cleaning between the hours when the restaurant is closed and when it reopens the next morning. In such an instance, the automated and/or robotic floor-care device could have a time requirement of several hours and would be able to exploit the use of this (longer) time period (in contrast to the above-noted urgent cleaning example) to reduce other variables such as solution amount/concentration and agitation time.

Other variables related to operations of the automated and/or robotic floor-care device can include, for example, power management (battery reserve and recharging), travel speed while cleaning, travel direction while cleaning, time of agitation, speed of agitation, downforce of agitation, fresh/clean water level, gray water level, cleaning solution level, rate of solution floor soaking (volume per area), dilution and/or mixture of solution concentration (controlled through the automated and/or robotic floor-care device or a docking station), mixture ratio of fresh water to gray water, pressure of spray (either rinse or concentration), heat applied to a solution by the automated and/or robotic floor-care device, solution-specific, time of ultraviolet (UV) light exposure, etc.

As further detailed herein, one or more embodiments of the invention can include programming an automated and/or robotic floor-care device for several types of floor-care operations or missions. For example, a commissioning mission can be carried out with the assistance of a human to define the one or more areas to be cleaned. By way merely of example, there may be five different areas of a kitchen that are to be cleaned. The human operator would signal to the automated and/or robotic floor-care device to learn one or more defined areas, and the automated and/or robotic floor-care device operator would guide the automated and/or robotic floor-care device around the defined area(s) to be cleaned. The automated and/or robotic floor-care device would then memorize the areas as unique areas and calculate the area of the floor to be cleaned for each instance. In one or more embodiments of the invention, the automated and/or robotic floor-care device can additionally seek from the human operator such information as how dirty is the area on a scale of 1-5, etc. Such additional information can provide the automated and/or robotic floor-care device some input as to how much cleaning solution or time to spend on a given portion of the area.

Another type of mission can include a programmed mission, which can be carried out for periodic cleaning of a given area. Such missions can be programmed for any given period (such as, for example, daily), and all of the parameters for this type of mission would be pre-programmed into the automated and/or robotic floor-care device. This type of mission can be carried out automatically by the automated and/or robotic floor-care device based, for example, on the time of day or on-demand by an operator. By way of example, a programmed mission can include a scenario wherein an automated and/or robotic floor-care device is programmed to clean the main aisles of a kitchen and dining room floors every night at 11:00 PM, and to complete its mission by 4:00 AM.

Additionally, another type of mission can include a spot mission, which can be executed when the automated and/or robotic floor-care device is called upon to clean a specific spot and/or portion of a floor. Such a mission is typically related to non-scheduled events such as spills or accidents of some type. For such a mission, a human operator of the automated and/or robotic floor-care device can manually define an area to be cleaned, and/or can drive or guide the automated and/or robotic floor-care device to the area to be cleaned. Also, spot missions can be accomplished via a predefined program that covers a specifically-sized area (such as a 4-foot by 4-foot square). For example, the user can position the automated and/or robotic floor-care device in the lower right hand corner of a square (or other user-defined shape), select the desired size of the square (or other user-defined shape) to be cleaned, then activate the automated and/or robotic floor-care device to execute the cleaning operation.

Also, at least one embodiment of the invention can include implementation of a mission update. In such an embodiment, the automated and/or robotic floor-care device can incorporate the ability to detect one or more changes in the surrounding environment, and these changes can be reported to a data log of the floor-care system, one or more appropriate human operators, etc. The automated and/or robotic floor-care device can then be informed, for example, if the changes are permanent, and if so, the automated and/or robotic floor-care device can adjust the programming to its new environment.

As also detailed herein, an automated and/or robotic floor-care device utilized in accordance with one or more embodiments of the invention can include navigation and localization capabilities. Variables and/or inputs for navigation and localization can include, for example, a combination of sensors such as one or more on-board sensors to determine if an obstacle is in the path of the automated and/or robotic floor-care device, and use of one or more external references to accurately locate the position of the automated and/or robotic floor-care device. An automated and/or robotic floor-care device can also include a navigation system, which can include sonar, tile navigation, spinning LIDAR, single-point laser range finders, inertial navigation sensors (such as a gyroscope), etc.

Additionally, in one or more embodiments of the invention, an automated and/or robotic floor-care device can also include an obstacle avoidance system and/or a bumper system which can include touch-sensitive sensors, active sonar, and/or on-board light curtains.

In accordance with one or more embodiments of the invention, an automated and/or robotic floor-care device can also include a water disposal component, which can include a suction system and/or a squeegee system wherein the automated and/or robotic floor-care device squeegees dirty water into a drain. An automated and/or robotic floor-care device can also be equipped with a gray water control system, which can include a secondary collection tank that can serve as a water source. In such an embodiment, the automated and/or robotic floor-care device can continuously monitor the cleanliness of the flow of the gray water and add and/or mix-in the appropriate amount of fresh water to achieve one or more cleanliness objectives. The gray water control system may also be equipped with a UV light to eliminate microbes.

One or more embodiments of the invention can also include equipping an automated and/or robotic floor-care device with a heated water tank and/or a heater positioned in the output stream (post gray/fresh/solution mixture). Also, an automated and/or robotic floor-care device can further be equipped with external communications capabilities that can be utilized, for example, to alert a floor-care system (or human user thereof) of one or more difficulties and/or potential failures. Further, in one or more embodiments of the invention, the automated and/or robotic floor-care device utilized can be of a certain size, such as, for example, sufficiently small as to operate under the edge of most common kitchen equipment.

In at least one embodiment of the invention, an automated and/or robotic floor-care device can be implemented with one or more optional and off-board technologies. For example, such an embodiment can include utilizing a docking station, which can be connected to clean water, can store cleanser, can be connected to a drain, can provide charge, can swap batteries, and can provide one or more server functions (for example, external communications, data storage, off-line processing, etc.). An automated and/or robotic floor-care device can, in such an embodiment, navigate to a docking station for additional solution, or for re-mixing of an existing solution. Additionally, an automated and/or robotic floor-care device can detect a low battery charge and self-swap one or more batteries at a docking station.

Further, using predictive analytics, a docking station can gather information regarding on-site cleanliness, analyze one or more environment variables, and predict one or more necessary on-board requirements. For example, such predictive analytics can determine the areas that require more or less cleaning based on historical cleaning information. Using such a determination, an automated and/or robotic floor-care device can adjust a cleaning operation or mission, and move faster (“skim clean”) through a particular area that is normally very clean. To skim clean, the automated and/or robotic floor-care device can take one or more specific measurements to determine if the area can be skim cleaned, the measurements would be compared to a predictive model, and the output of the model would determine the level of cleaning to be performed in the area.

As also detailed herein, in accordance with one or more embodiments of the invention, an automated and/or robotic floor-care device can be equipped with a cleanser tank, which can include a reserve tank of cleaning solution/agent on-board the automated and/or robotic floor-care device (whereby the automated and/or robotic floor-care device can utilize the reserve solution/agent to increase concentration levels, if needed/desired). An automated and/or robotic floor-care device can also be equipped with a gray water recycling component, which allows the automated and/or robotic floor-care device to reuse gray water. Such a component can include a particulate filter, and an in-line UV sterilizing light.

Further, in at least one embodiment of the invention, an automated and/or robotic floor-care device can be equipped with a variable force brush component, whereby a brush mount can rotate to different positions to alter the resulting downward force of the brush. Such a component can also enable adjustment of the angle of a brush with respect to a surface. Also, for example, a floating brush system can be implemented to allow for the cleaning of ramps.

As noted herein, the operation of the information processing system 100 is described in further detail with reference to the flow diagram of the example embodiment of FIG. 4. The process as shown includes steps 400 through 408, and is suitable for use in the system 100 but is more generally applicable to other systems comprising a processing platform having cloud infrastructure representation functionality. Accordingly, references to components of the embodiment of FIG. 1 in the process description below should not be viewed as limiting in any way, as the disclosed process steps can be applied in a wide variety of other types of information processing systems.

In step 400, at least one processing platform is configured to include one or more processing devices, each comprising a processor coupled to a memory. In the context of the FIG. 1 embodiment, information processing system 100 comprises processing platforms 106 and 106′ as illustrated in the figure. The one or more additional processing platforms 106′ may be configured in substantially the same manner as the processing platform 106. Each such processing platform comprises system resources 110 (for example, virtual resources) for use by client applications.

In step 402, at least a portion of at least a first floor care system are implemented within the processing platform. For example, with reference to the FIG. 1 embodiment, such a portion of at least a first floor-care system can include system resources 110 of floor-care system 112 implemented within processing platform 106. As mentioned previously, such system resources 110 can include virtual resources illustratively comprising containers, virtual machines or combinations thereof. The at least a portion of at least the first floor-care system can include, for example, one or more recommended floor-care variable values.

In step 404, multiple floor-care variables input by at least the first floor-care system are monitored during run-time of a floor-care operation in connection with a given space. Such a step can be carried out, for example, by floor-care input variable monitoring module 114 in the FIG. 1 embodiment. In one or more embodiments of the invention, the multiple floor-care variables can include an amount of time allocated for completing the floor-care operation, a temperature of one or more cleaning solutions used during the floor-care operation, remaining battery charge of the apparatus, an agitation value associated with one or more cleaning actions carried out in accordance with the floor-care operation, a relative humidity value attributed to the given space, an ambient temperature value attributed to the given space, an amount of area associated with the floor-care operation within the given space, and/or one or more values pertaining to use of ultraviolet light in connection with the floor-care operation.

In step 406, one or more of multiple floor-care execution outputs are adjusted in response to the monitoring of the multiple floor-care variables. Such a step can be carried out, for example, by floor-care execution adjustment module 116 in the FIG. 1 embodiment. In at least one embodiment of the invention, the at least a portion of at least the first floor-care system can include an algorithm for balancing, in connection with the floor-care operation, one or more temporal parameters, an agitation value associated with one or more cleaning actions, a concentration value associated with one or more cleaning agents, and one or more temperature parameters. Further, in such an embodiment, the floor-care execution adjustment module 116 can be further configured to implement the algorithm to rebalance, in response to the one or more adjusted floor-care execution outputs, the one or more temporal parameters, the agitation rate associated with one or more cleaning actions, the concentration value associated with one or more cleaning agents, and the one or more temperature parameters.

Also, in one or more embodiments of the invention, the floor-care execution adjustment module can be further configured to calculate a minimum value and a maximum value for each of the multiple floor-care execution outputs, as well as to adjust the one or more floor-care execution outputs from a default position pre-defined as a mid-point between the calculated minimum value and the calculated maximum value to an adjusted position between the calculated minimum value and the calculated maximum value.

In step 408, at least a portion of the multiple floor-care execution outputs are executed during at least a portion of the floor-care operation based on the one or more adjusted floor-care execution outputs. Such a step can be carried out, for example, by floor-care output module 118 in the FIG. 1 embodiment.

The particular processing operations and other system functionality described in conjunction with the flow diagram of FIG. 4 are therefore presented by way of illustrative example only, and should not be construed as limiting the scope of the disclosure in any way. Alternative embodiments can use other types of processing operations involving cloud infrastructure representation. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another in order to carry out the techniques of one or more embodiments of the invention detailed herein.

Functionality such as that described in conjunction with the flow diagram of FIG. 4 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of optimizing automated floor-care devices as disclosed herein can provide a number of significant advantages relative to conventional arrangements.

For example, some embodiments can advantageously optimize a floor-care or cleaning process and minimize the use of chemicals and energy in doing so. Additionally, one or more embodiments can increase work environment safety by reducing bacteria and fall hazards.

Such arrangements overcome the difficulties that would otherwise be associated with automated floor-care devices that fail to implement objective measurements of cleanliness.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment. In some embodiments, the cloud infrastructure additionally or alternatively comprises a plurality of containers implemented using container host devices. The containers may run on virtual machines in a multi-tenant environment, although other arrangements are possible. The containers may be utilized to implement a variety of different types of functionality within the system 100. Also, containers may be used in combination with other virtualization infrastructure such as virtual machines implemented using a hypervisor.

Illustrative embodiments of processing platforms will now be described in greater detail with reference to FIG. 5. Although described in the context of system 100, these platforms may also be used to implement at least portions of other information processing systems in other embodiments.

The processing platform 500 in this embodiment comprises a portion of system 100 and includes a plurality of processing devices, denoted 502-1, 502-2, 502-3, . . . 502-K, which communicate with one another over a network 504.

The network 504 may comprise any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 502-1 in the processing platform 500 comprises a processor 510 coupled to a memory 512.

The processor 510 may comprise a microprocessor, a microcontroller, an application-specific integrated circuit (ASIC), a field-programmable gate array (FPGA) or other type of processing circuitry, as well as portions or combinations of such circuitry elements.

The memory 512 may comprise random access memory (RAM), read-only memory (ROM) or other types of memory, in any combination. The memory 512 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 502-1 is network interface circuitry 514, which is used to interface the processing device with the network 504 and other system components, and may comprise conventional transceivers.

The other processing devices 502 of the processing platform 500 are assumed to be configured in a manner similar to that shown for processing device 502-1 in the figure.

Again, the particular processing platform 500 shown in the figure is presented by way of example only, and system 100 may include additional or alternative processing platforms, as well as numerous distinct processing platforms in any combination, with each such platform comprising one or more computers, servers, storage devices or other processing devices.

As noted herein, it should be understood that in one or more embodiments of the invention, different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

It should again be emphasized that the above-described embodiments are presented for purposes of illustration only. Many variations and other alternative embodiments may be used. For example, the disclosed techniques are applicable to a wide variety of other types of information processing systems in which it is desirable to optimize automated floor-care devices. Also, the particular configurations of system and device elements and associated processing operations illustratively shown in the drawings can be varied in other embodiments. Thus, for example, the particular types of processing platforms, modules, systems, cloud-based systems, resources, and virtual resources deployed in a given embodiment and their respective configurations may be varied. Moreover, the various assumptions made above in the course of describing the illustrative embodiments should also be viewed as exemplary rather than as requirements or limitations of the invention. Numerous other alternative embodiments within the scope of the appended claims will be readily apparent to those skilled in the art.

What is claimed is:

1. An apparatus comprising:
at least one processing platform comprising one or more processing devices each comprising a processor coupled to a memory;
the processing platform being configured to implement at least a portion of at least a first floor-care system;
wherein the processing platform further comprises:
a floor-care input variable monitoring module configured to monitor, during run-time of a floor-care operation in connection with a given space, multiple floor-care variables input by at least the first floor-care system;
a floor-care execution adjustment module configured to adjust one or more of multiple floor-care execution outputs in response to the monitoring of the multiple floor-care variables; and
a floor-care output module configured to execute at least a portion of the multiple floor-care execution outputs during at least a portion of the floor-care operation based on the one or more adjusted floor-care execution outputs.

2. The apparatus of claim 1, wherein the at least a portion of at least the first floor-care system comprises an algorithm for balancing, in connection with the floor-care operation, one or more temporal parameters, an agitation value associated with one or more cleaning actions, a concentration value associated with one or more cleaning agents, and one or more temperature parameters.

3. The apparatus of claim 2, wherein the floor-care execution adjustment module is further configured to implement the algorithm to rebalance, in response to the one or more adjusted floor-care execution outputs, the one or more temporal parameters, the agitation rate associated with one or more cleaning actions, the concentration value associated with one or more cleaning agents, and the one or more temperature parameters.

4. The apparatus of claim 1, wherein the floor-care execution adjustment module is further configured to calculate a minimum value and a maximum value for each of the multiple floor-care execution outputs.

5. The apparatus of claim 4, wherein the floor-care execution adjustment module is further configured to adjust the one or more floor-care execution outputs from a default position pre-defined as a mid-point between the calculated minimum value and the calculated maximum value to an adjusted position between the calculated minimum value and the calculated maximum value.

6. The apparatus of claim 1, wherein the at least a portion of at least the first floor-care system comprises one or more recommended floor-care variable values.

7. The apparatus of claim 1, wherein the multiple floor-care variables comprise an amount of time allocated for completing the floor-care operation.

8. The apparatus of claim 1, wherein the multiple floor-care variables comprise a temperature of one or more cleaning solutions used during the floor-care operation.

9. The apparatus of claim 1, wherein the multiple floor-care variables comprise remaining battery charge of the apparatus.

10. The apparatus of claim 1, wherein the multiple floor-care variables comprise an agitation value associated with one or more cleaning actions carried out in accordance with the floor-care operation.

11. The apparatus of claim 1, wherein the multiple floor-care variables comprise at least one of a relative humidity value attributed to the given space, an ambient temperature value attributed to the given space, and an amount of area associated with the floor-care operation within the given space.

12. The apparatus of claim 1, wherein the multiple floor-care variables comprise one or more values pertaining to use of ultraviolet light in connection with the floor-care operation.

13. A method comprising steps of:
monitoring, during run-time of a floor-care operation in connection with a given space, multiple floor-care variables input by at least a first floor-care system;
adjusting one or more of multiple floor-care execution outputs in response to the monitoring of the multiple floor-care variables; and
executing at least a portion of the multiple floor-care execution outputs during at least a portion of the floor-care operation based on the one or more adjusted floor-care execution outputs;
wherein the monitoring, adjusting, and executing steps are implemented in at least one processing platform configured to include one or more processing devices each comprising a processor coupled to a memory; and
wherein the processing platform is configured to implement at least a portion of at least the first floor-care system.

14. The method of claim 13, wherein the at least a portion of at least the first floor-care system comprises an algorithm for balancing, in connection with the floor-care operation, one or more temporal parameters, an agitation value associated with one or more cleaning actions, a concentration value associated with one or more cleaning agents, and one or more temperature parameters.

15. The method of claim 14, further comprising:
implementing the algorithm to rebalance, in response to the one or more adjusted floor-care execution outputs, the one or more temporal parameters, the agitation rate associated with one or more cleaning actions, the concentration value associated with one or more cleaning agents, and the one or more temperature parameters.

16. The method of claim 13, further comprising:
calculating a minimum value and a maximum value for each of the multiple floor-care execution outputs; and
adjusting the one or more floor-care execution outputs from a default position pre-defined as a mid-point between the calculated minimum value and the calculated maximum value to an adjusted position between the calculated minimum value and the calculated maximum value.

17. A computer program product comprising a non-transitory processor-readable storage medium having stored therein program code of one or more software programs, wherein the program code when executed by a processing platform comprising one or more processing devices causes the processing platform:
to monitor, during run-time of a floor-care operation in connection with a given space, multiple floor-care variables input by at least a first floor-care system;
to adjust one or more of multiple floor-care execution outputs in response to the monitoring of the multiple floor-care variables; and
to execute at least a portion of the multiple floor-care execution outputs during at least a portion of the floor-care operation based on the one or more adjusted floor-care execution outputs;
wherein the processing platform is configured to implement at least a portion of at least the first floor-care system.

18. The computer program product of claim 17, wherein the at least a portion of at least the first floor-care system comprises an algorithm for balancing, in connection with the floor-care operation, one or more temporal parameters, an agitation value associated with one or more cleaning actions, a concentration value associated with one or more cleaning agents, and one or more temperature parameters.

19. The computer program product of claim 18, wherein the program code further causes the processing platform:
to implement the algorithm to rebalance, in response to the one or more adjusted floor-care execution outputs, the one or more temporal parameters, the agitation rate associated with one or more cleaning actions, the concentration value associated with one or more cleaning agents, and the one or more temperature parameters.

20. The computer program product of claim 17, wherein the program code further causes the processing platform:
to calculate a minimum value and a maximum value for each of the multiple floor-care execution outputs; and
to adjust the one or more floor-care execution outputs from a default position pre-defined as a mid-point between the calculated minimum value and the calculated maximum value to an adjusted position between the calculated minimum value and the calculated maximum value.
